(19) United States
(12) Patent Application Publication
(10) Pub. No.: US 2023/0104930 A1
(43) Pub. Date: Apr. 6, 2023

(54) Charge Adapter for Charging a Vehicle Battery

(71) Applicant: Bayerische Motoren Werke Aktiengesellschaft, Muenchen (DE)

(72) Inventors: Joachim FROESCHL, Herrsching (DE); Christian PFEIFFER, Egenhofen (DE)

(21) Appl. No.: 17/913,531

(22) PCT Filed: Feb. 15, 2021
(86) PCT No.: PCT/EP2021/053660

§ 371 Date: Sep. 22, 2022

(30) Foreign Application Priority Data
Mar. 26, 2020 (DE) 10 2020 108 363.7

(51) Int. Cl. H02J 7/00; H02J 50/10; H02J 50/00

(52) U.S. Cl. CPC H02J 7/0045; H02J 50/10; H02J 50/005; H02J 7/007; H02J 7/00036; H02J 2207/20; B60R 16/033

(57) ABSTRACT

A charge adapter for charging a vehicle battery includes a support and a charging coil which is secured to the support and is configured to generate an alternating charging current in response to a magnetic charging field. The charge adapter additionally includes a rectifier which is secured to the support and is configured to generate a rectified charging current based on the alternating charging current. The charge adapter additionally includes a plus contact which is secured to the support and a minus contact which is secured to the support, and which are configured to be plugged onto a plus pole and a minus pole of a vehicle battery, respectively. The charge adapter further includes lines which are configured to conduct the rectified charging current to the plus contact and the minus contact.

### BACKGROUND AND SUMMARY OF THE INVENTION

The invention relates to a charge adapter which makes it possible to charge a vehicle battery in an efficient, precise and convenient way.

A vehicle typically comprises a vehicle battery, in particular a lead battery, which is designed to store electrical energy for the operation of electrical loads in the vehicle. A vehicle battery (in particular a lead starter battery) typically has a relatively high level of self-discharge. This can lead to elevated ageing in the event of a relatively long and/or deep discharge of the battery. For this reason, a vehicle battery, in particular a lead battery, should be charged as completely as possible in order to prolong the life of the battery.

The present document deals with the technical object of enabling efficient, precise and convenient charging of a vehicle battery (in particular during the manufacture of a vehicle and/or during the storage of a vehicle battery).

The object is achieved by the claimed invention.

According to one aspect, a charge adapter for charging a vehicle battery is described. The charge adapter can be designed to charge a 12 V vehicle battery, a lead battery and/or a starter battery for a (motor) vehicle. The vehicle battery can, for example, have a storage capacity of 50 Ah or more. The charge adapter can be designed as a pluggable attachment, which can be plugged onto the cover and/or onto the top of a vehicle battery. For example, contacts of the charge adapter can be designed in such a way that the contacts can be plugged onto appropriate poles on the cover and/or on the top of a vehicle battery, in order to hold the charge adapter on the cover and/or the top of the vehicle battery.

The charge adapter comprises a support. The support can be designed as a plate, in particular a rigid plate (which, for example, at least partly or completely covers the cover and/or the top of a vehicle battery). Alternatively, the support can be designed as a film, in particular as an adhesive film (which, for example, can be laid on or stuck to the cover or the top of a vehicle battery). The different components of the charge adapter can be held together via the support.

Furthermore, the charge adapter comprises a charging coil which is secured to the support and is designed to generate an alternating charging current in response to a magnetic charging field. The magnetic charging field can be generated, for example, by an inductive charging device, wherein the inductive charging device typically has a coil that is complementary to the charging coil of the charge adapter. The magnetic charging field can be an alternating field, for example with a charging field frequency in the range between 30 kHz and 120 kHz.

The charging coil can comprise, or in particular be, a flat coil. The one or more windings of the charging coil can be arranged parallel to the support of the charge adapter (and/or parallel to the cover and/or the top of a vehicle battery). In particular, the charging coil can be arranged on the support in such a way that to charge a vehicle battery, an inductive charging device which is designed to generate the magnetic charging field can be laid on the carrier (and as a result, an alternating charging current is induced in the charging coil). Alternatively or additionally, the charging coil can be arranged on the support in such a way that the coupling factor between a coil of an inductive charging device and the charging coil is at a maximum when the inductive charging device is laid on the support. Thus, a convenient and energy-efficient charging process of a vehicle battery can be enabled.

The charge adapter comprises a rectifier (for example a switched rectifier and/or a diode rectifier) which is secured to the carrier and which is set up to generate a rectified charging current on the basis of the alternating charging current. Furthermore, the charge adapter can comprise a charging controller, which is set up to adjust, in particular to control (to a respective setpoint), the charging current and/or a charging voltage (on the vehicle battery) during the charging process of a vehicle battery (when the charge adapter is plugged onto a vehicle battery). Thus, a particularly reliable charging process of a vehicle battery can be enabled.

In addition, the charge adapter comprises a plus contact which is secured to the support and a minus contact which is secured to the support, which are designed to be plugged onto the plus pole and onto the minus pole of a vehicle battery (in order to couple the charge adapter galvanically conductively to the vehicle battery). The contacts and the poles can be designed to be complementary to one another.

The charge adapter further comprises lines which are designed to conduct the rectified charging current to the plus contact and the minus contact. The rectified charging current provided at the rectifier can then be led via the lines and via the contacts to the poles of the vehicle battery to be charged. At least one of the lines can have a fuse, in particular a fusible link. Thus, a particularly safe charging process can be enabled.

Thus, a charge adapter is described which, to charge a vehicle battery, can be placed on the vehicle battery and thus enables a reliable and convenient charging process.

The plus contact and/or the minus contact of the charging device can be arranged displaceably on the support. In other words, the plus contact and/or the minus contact can be arranged on the support in such a way that the spacing between the plus contact and the minus contact is variable. In particular, the plus contact and/or the minus contact can be arranged displaceably on the support via a rail. The charge adapter can thus be designed in such a way that the spacing between the contacts and/or the position of a contact can be varied. Thus, the charge adapter can be adapted conveniently to different types of vehicle batteries.

The charge adapter can comprise a display (in particular a monitor). Furthermore, the charge adapter can comprise a control unit which is set up to determine data relating to the charging current, relating to the battery voltage and/or relating to the temperature of the vehicle battery. The data can be provided via one or more sensors (e.g. a current sensor, a voltage sensor and/or a temperature sensor) of the charge adapter. Furthermore, the control unit can be set up to output the determined data via the display. It can thus be made possible for a user to monitor a charging process particularly reliably and conveniently.

The charge adapter can comprise a communication unit which is set up to transmit data relating to the vehicle battery (to be charged) and/or relating to the charging process of the vehicle battery via a communication link, in particular via a wire-free communication link. In particular, data relating to the charging current, relating to the battery voltage and/or relating to the temperature of the vehicle battery can be transmitted via the communication link. Thus, the convenience of a charging process can be increased further. In particular, remote monitoring of a charging process can thus be enabled.

The control unit of the charge adapter can be set up to determine spacing information relating to the set spacing between the plus contact and the minus contact. Furthermore, the control unit can be set up to control a charging process of the vehicle battery to which the charge adapter is secured and/or plugged on, depending on the spacing information. Thus, charging processes for different types of vehicle batteries can be enabled in a reliable and convenient way.

According to a further aspect, a (road-going) motor vehicle (in particular a passenger car or a truck or a bus) is described which comprises the charge adapter described in this document.

According to a further aspect, a charging rack is described which comprises a storage surface for a plurality of vehicle batteries to be charged and a corresponding plurality of charge adapters. Furthermore, one or more inductive charging devices can be arranged on the charging rack.

It should be noted that the devices and systems described in this document can be used both on their own and also in combination with other devices and systems described in this document. Furthermore, any aspects of the devices and systems described in this document can be combined with one another in a variety of ways. In particular, the features of the claims can be combined with one another in a variety of ways.

The invention will be described in more detail below by using exemplary embodiments.

### BRIEF DESCRIPTION OF THE DRAWINGS

FIG. 1a shows an example of a vehicle battery with a charge adapter.

FIG. 1b shows an example of a charge adapter.

### DETAILED DESCRIPTION OF THE DRAWINGS

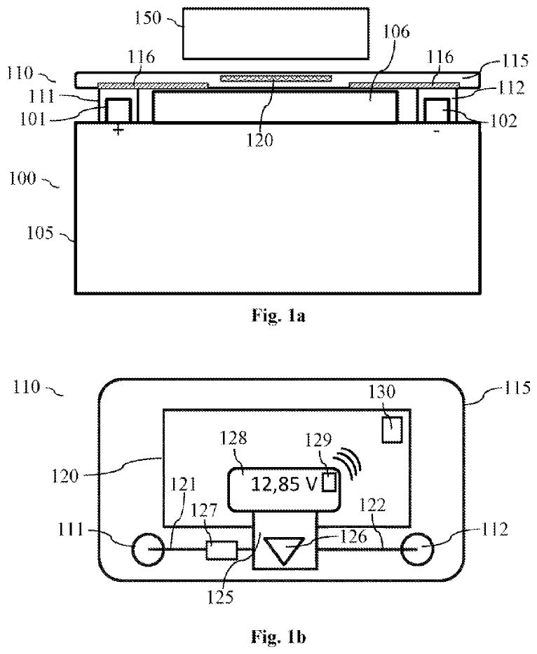

As explained at the outset, the present document deals with enabling efficient and convenient charging of a vehicle battery. In this connection, FIG. 1a shows an example of a vehicle battery 100, in particular a lead battery and/or a starter battery and/or a 12 V battery. The battery 100 comprises a plus pole 101 and a minus pole 102, which are typically arranged on the top of the housing 105 of the battery 100. The poles 101, 102 are typically connected in a vehicle to power lines of the on-board electrical system of the vehicle.

Furthermore, FIG. 1a shows an example of a charge adapter 110 having a support 115. Arranged (in particular secured) on the support 115 is a plus contact 111, which is designed to be (electrically conductively) connected to the plus pole 101 of the battery 100. Furthermore, arranged (in particular secured) on the carrier is a minus contact 112, which is designed to be (electrically conductively) connected to the minus pole 102 of the battery. In particular, the charge adapter 110 can be designed in such a way that the contacts 111, 112 can be plugged onto the corresponding poles 101, 102, and thus the charge adapter 110 is held on the battery 100.

At least one of the contacts 111, 112 can be secured displaceably on the carrier 110, e.g. displaceably along a rail 116. Thus, it can be made possible to adapt the charge adapter 110 to batteries 110 of different dimensions and/or to different types of batteries 110.

As illustrated in FIG. 1b, the charge adapter 110 comprises a charging coil 120, which is designed for inductive energy transfer. The charging coil 120 can be arranged flat on the support 115 of the charge adapter 110. The charging coil 120 can be designed to generate an electric (alternating) current in response to a magnetic charging field. The induced current can be converted by a rectifier 125 into a (rectified) charging current for charging the vehicle battery 110. The rectified charging current can be led via lines 121, 122 to the contacts 111, 112 and into the vehicle battery 110.

The charge adapter 110 can thus be designed to pick up electrical energy from a charging apparatus 150 via a charging coil 120, and to pass the current onto the contacts 111, 112 to charge a vehicle battery 110.

Thus, a charge adapter 110 for charging a battery 100 (lead battery, lithium ion battery, etc.) is described which, for example, is designed as a pluggable attachment to be placed on the battery 100. The charge adapter 110 enables an inductive energy transfer from a charging device 150 to a vehicle battery 100.

The charge adapter 110 can be used to charge a battery 100 at the end of the battery production and/or during the storage of the battery 100 (without any electrical contact with a charging device 150). Alternatively or additionally, the charge adapter 110 can be used to charge the battery 100 in a store (e.g. at a vehicle dealer). The charge adapter 110 can be used for charging different batteries 100. The charge adapter 110 can also possibly be used to charge a battery 100 during a transport process.

The charge adapter 110 can be designed as a flat coil attachment with a diode coupling and/or with a rectifier 125. The attachment can have the size of the cover 106 of the battery 100. The charge adapter 110 can comprise a charging controller 126 in order to control the charging process, in particular the charging current. The support 115 of the charge adapter 110 can be designed as flexible films (e.g. as a battery type label), which can possibly be stuck onto the cover 106 of a battery 100.

As illustrated in FIG. 1b, a conductor track 121, 122 between the rectifier 115 and a contact 111, 112 can be designed as a (fusible) fuse 127. Thus, a short circuit during a charging process can reliably be prevented.

The spacing between the contacts 111, 112 can be designed to be variable or changeable. Thus, the charge adapter 110 can be adapted to different battery sizes. The spacing between the contacts 111, 112 provides a conclusion about the battery size. For example, a control unit 130 of the charge adapter 110 can be designed to determine the set spacing between the contacts 111, 112. The charging process of the battery 100 can then be carried out depending on the set spacing between the contacts 111, 112.

The charge adapter 110 can be designed as a battery pole covering, by which it is not the entire cover 106 of the battery 100 that is covered but only a region around the poles 101, 102 of the battery 100. Thus, a particularly compact charge adapter 110 can be provided.

The charge adapter 110 can comprise a display 128 which, for example, is designed to display the charging current, the battery voltage and/or the temperature of the battery 100. Furthermore, data relating to a charging process (e.g. the charging current, the battery voltage and/or the temperature) can be stored on a storage unit (not illustrated) and/or transmitted via a wire-free data transmission unit 129. Thus, for example, the quality of a charging process can be monitored and/or checked.

To charge a plurality of vehicle batteries 100, a charging rack having a plurality of inductive energy transceivers 150 (each having a transmission coil for one or more charge adapters 110, depending on the required output) can be provided. The vehicle batteries 100 can then be placed in the charging rack with charge adapters 110 and charged as needed.

By way of the charge adapter 110 described in this document, efficient and precise charging of a vehicle battery 100 can be enabled. Thus, the life of a vehicle battery 100 can be increased, since a low state of charge and/or a deep discharge can be avoided. The handling of a battery 100 during production, transport and/or storage can be simplified. If necessary, charging of one or more batteries 100 during transport can be enabled (e.g. energy harvesting on a truck or on a train). Furthermore, reliable and efficient monitoring of the batteries 100 (in particular when they are in store) can be enabled.

The present invention is not restricted to the exemplary embodiments shown. In particular, it should be noted that the description and the figures are intended to illustrate the principle of the proposed methods, devices and systems merely by way of example.

1.-12. (canceled)

13. A charge adapter for charging a vehicle battery, the charge adapter comprising:
a support;
a charging coil which is secured to the support and is configured to generate an alternating charging current in response to a magnetic charging field;
a rectifier which is secured to the support and which is configured to generate a rectified charging current based on the alternating charging current;
a plus contact secured to the support and a minus contact secured to the support, wherein the plus contact and the minus contact are configured to be plugged onto a plus pole and a minus pole of a vehicle battery, respectively; and
lines which are configured to conduct the rectified charging current to the plus contact and the minus contact.

14. The charge adapter according to claim 13, wherein the charge adapter is configured as a pluggable attachment, which is pluggable onto a cover of a vehicle battery.

15. The charge adapter according to claim 13, wherein the support is configured as a film.

16. The charge adapter according to claim 15, wherein the film is an adhesive film.

17. The charge adapter according to claim 13, wherein the support is configured as a plate.

18. The charge adapter of claim 17, wherein the plate is a rigid plate.

19. The charge adapter according to claim 13, wherein:
the plus contact and/or the minus contact is arranged displaceably on the support; and/or
the plus contact and/or the minus contact is arranged on the support such that a spacing between the plus contact and the minus contact is variable; and/or
the plus contact and/or the minus contact is arranged displaceably on the support via a rail.

20. The charge adapter according to claim 13, wherein:
the charging coil comprises a flat coil; and/or
the charging coil is arranged on the support such that to charge the vehicle battery, an inductive charging device which is configured to generate the magnetic charging field is arrangeable on the support; and/or
the charging coil is arranged on the support such that a coupling factor between a coil of an inductive charging device and the charging coil is at a maximum when the inductive charging device is arranged on the carrier.

21. The charge adapter according to claim 20, wherein the charging coil consists of the flat coil.

22. The charge adapter according to claim 13, further comprising:
a display; and
a control unit which is configured to:
determine data relating to the charging current, relating to a battery voltage and/or relating to a temperature of the vehicle battery; and
output the data via the display.

23. The charge adapter according to claim 13, further comprising a charging controller which is configured to adjust the charging current and/or a charging voltage during a charging process of the vehicle battery.

24. The charge adapter according to claim 23, wherein the charging controller is configured to control the charging current and/or a charging voltage during a charging process of the vehicle battery.

25. The charge adapter according to claim 13, further comprising a communication unit which is configured to transmit data relating to the vehicle battery and/or relating to a charging process of the vehicle battery via a communication link.

26. The charge adapter according to claim 25, wherein the communication link is a wire-free communication link.

27. The charge adapter according to claim 13, further comprising a control unit which is configured to:
determine spacing information relating to a set spacing between the plus contact and the minus contact; and
control a charging process of the vehicle battery to which the charge adapter is secured, depending on the spacing information.

28. The charge adapter according to claim 13, wherein at least one of the lines has a fuse.

29. The charge adapter according to claim 28, wherein the fuse is a fusible link.

30. The charge adapter according to claim 13, wherein:
the charge adapter is configured to charge a 12 V vehicle battery; and/or
the charge adapter is configured to charge a lead battery; and/or
the charge adapter is configured to charge a starter battery.
